(19) United States
(12) Patent Application Publication
(10) Pub. No.: US 2006/0127285 A1
(43) Pub. Date: Jun. 15, 2006

(54) Method and apparatus for flameless carbon black deposition

(76) Inventor: William A. Von Drasek, Oak Forest, IL (US)

Correspondence Address: AIR LIQUIDE, 2700 POST OAK BOULEVARD, SUITE 1800, HOUSTON, TX, 77056, US

(21) Appl. No.: 11/095,266

(22) Filed: Mar. 31, 2005

Related U.S. Application Data
(60) Provisional application No. 60/634,932, filed on Dec. 10, 2004.

(51) Int. Cl. B32B 27/04

(52) U.S. Cl. 422/150

(57) ABSTRACT

The methods and apparatuses for producing carbon black. The invention uses both heating and cooling zones to prevent the precipitation of solids onto equipment surfaces until they are efficiently removed from the gas phase, via one or more heat exchangers. Each heat exchanger may be regenerated to melt off the solids when the amount collected becomes excessive. A storage plenum is available under each heat exchanger to store the melted solids until final removal to avoid the need to open the equipment for the removal of the unwanted solids.

### CROSS REFERENCE TO RELATED APPLICATIONS

This application claims the benefit of U.S. Provisional Application No. 60/634,932, filed Dec. 10, 2004, the entire contents of which are incorporated herein by reference.

### BACKGROUND

Technologies used for carbon black generation vary from local combustion processes to large-scale high volume carbon black generators. Carbon black, produced from the high volume generators, is used in manufacturing a diverse range of material such as tires, pigments, coatings, toners, and plastics. For these applications, carbon black is produced by carefully controlled combustion of residual oil feedstock. For example, Cabot Corporation produces nearly two (2) million tons of carbon black annually using this process.

In smaller volume applications that require a local or spot deposition of carbon black (e.g., in the glass mold or pressing operations), the technology used is predominately from combustion of C₂H₂, such as the process developed by Air Liquide, that uses a continuous oxy-fuel premixed pilot flame and C₂H₂ for carbon generation. For a typical application in glass mold lubricating, every “n” cycles from a container manufacturing glass mold (gob injection), where typically 5<n<10, is subjected to a mixture of gaseous hydrocarbons usually from C₂H₂, resulting from the pulse (this pulse typically having a duration of <1 sec) of C₂H₂ through the pilot flame.

The oxy-fuel pilot flame has an adiabatic flame temperature of 3030° K and accounting for heat losses the pilot flame temperature is closer in the range of 2400-2600° K. The pilot flame gases used are oxygen and natural gas, the mixture being fuel lean (equivalence ratio defined as (Oxidant/Fuel)/(Oxidant/Fuel)_{theory}: 1.1 to 1.4). Alternative pilot fuels, such as propane, can be used in place of natural gas. This fuel lean ratio is aimed at better controlling the temperature and the shape of the flame. Consequently, the lean natural gas flame will not produce any soot near the injector because it will oxidize carbon particles. Thus, this eliminates maintenance issues from carbon build-up.

The mixture of gaseous hydrocarbons comprises at least 15% of a constituent with respect of which the atom number ratio C/H is higher than 0.75. The hydrocarbon may be acetylene, propyne, benzene, acetylene-ethylene mixtures, mixtures constituted by propyne-propadiene-propylene, and other C₃ and C₄ hydrocarbons.

Heat and radicals (e.g., OH⁻, O⁼, etc.) provided by the pilot flame crack the hydrocarbon molecules, thus depositing a porous layer of carbon particles on the inside of the mold, before contact with a hot glass gob. After the glass article is removed from the mold, any residual carbon on the glass surface will burn off in air.

There are a number of competing technologies for generating carbon black. Most of these technologies use the same basic principle described above for the ALBLACK™ technology, i.e., formation of carbon black from C₂H₂ using an ignition source. A summary of technologies used for carbon black formation is provided below.

The Linde process is described in German Patent No. 4,311,773 (1994). A chamber is placed next to the surface to lubricate either a mold or a conveyor. An electric spark ignites an acetylene-air pilot flame, as shown in FIG. 1. Then the chamber is filled with a fuel rich mixture containing air and acetylene. This filling lasts for a determined period of time (0.05 to 2 sec) at beginning, of which the pilot flame is shut down. Another way to conduct the process is to let the pilot flame run permanently. The chamber works also as a shield, so that no soot gets in the surrounding atmosphere, and all of it is directed toward the surface to be coated. Thus, just a small amount of soot is lost and gas is saved. The acetylene-air mixture may be replaced by any carbon rich mixture containing 1 to 40% of oxygen in volume (1 to 10% is better). An automatic device is used to control gas inlets and ignition.

The AVIR process is described in U.S. Pat. No. 5,746,800 (1998). The bottom plunger of the mold, which allows air inlet for gob blowing, is removed. Thus, there is a hole at the bottom of the mold and no reverberation of the sooting flame occurs. Then acetylene is filled in first with reduced flow, when the ignition occurs, not to blow out the spark, and then with full flow. The ignition source is piezoelectric, as shown in FIG. 1, but a voltaic arc, or an electric resistance could also work. Finally, the acetylene flow is shut down. The gob drops in and the air plunger is put back into the bottom of the mold. In this process, the mold does not have to be open on its sides.

The T. A. Seeman's process is described in U.S. Pat. No. 5,679,409 (1996). T. A. Seeman uses MAPD (a mixture of methyl acetylene and propadiene), and oxygen that are mixed in a venturi, and delivered to and through a nozzle, which is directed towards a glass-contacting surface. The mixture is ignited as it leaves the nozzle by a natural gas pilot flame. Its flow is controlled so that the temperature of the flame is between 1500-1800° K.

In German Patent No. 4,340,062 (1995), Linde describes another process to deposit carbon black, with an ignition initiated by the hot glass itself. The mold is filled in with a fuel rich mixture containing oxygen (or air) and a gaseous hydrocarbon (such as acetylene). The temperature of this mixture has to be lower than a threshold value. Then, the hot thermoplastic mass is put in the mold. Due to its high temperature, an ignition is created in the gaseous mixture, cracking it and thus producing carbon black. This carbon black is then deposited onto the surfaces of both the mold and the thermoplastic mass. Before the ignition, an inert gas or a gas containing oxygen may be filled in, so that the carbon rich mixture is not ignited in an air atmosphere.

U.S. Pat. No. 4,526,600 (1983) from Brockway explains a process for sooting the glass gob itself. Powdered graphite is sprayed onto the glass gob by being fed into the combustion gas for a flame contacting the glass ahead of the mold.

A few companies have developed permanently lubricated molds, by using special alloys, on which special permanent and semi-permanent coatings are deposited. One alternative is either plasma-sprayed or powder-sprayed metallic coating using materials such as molybdenum, nickel-molybdenum, chromium, and nickel-graphite. Another alternative is an electrolytically deposited plating using chromium-tungsten oxide. Yet another alternative is electroless nickel coating. But today, all these alternatives remain too expensive to have industrial viability.

There have been a number of ideas for improvement of these known technologies.

German Patent No. 4,341,876 (1995), Linde, and U.S. Pat. No. 4,879,074 (1989), UBE, report the use of an electric field to deposit carbon black. The burner and the melt surface to be coated are charged with opposite electrical polarities to thereby cause an electrodeposition of the soot. Thus, carbon black is better directed to the surface, and less of it is wasted. This technology relies on the existence of an induced dipolar moment in soot. The voltage applied varies from 500 to 30,000 V. While this invention has received patent protection, it does not appear to have ever been implemented.

A method to control carbon black quality is described in European Patent No. 0,367,029 (1990), Messer Griesheim. The operator modifies the O₂ flow rate, and can thus control a few characteristics of the coating, such as its porosity, and its greasiness. This process is very similar to Linde, AVIR, or ALBLACK™, by igniting a gas mixture jet with the flame surrounded by the mold surfaces. It is interesting to note that this patent was withdrawn in 1992 in Europe and in 1998 in Germany.

A method of subsequent treatment of the coating is described in English Patent No. 2,221,413 (1988). The carbon black layer is subjected to a subsequent treatment, in which a substantially neutral flame is applied. This results in homogenization of the particles of the layer to produce a stronger layer that better protects the underlying surface. The thickness of the treated soot layer may be reduced by subsequently applying an oxidizing flame

Another alternative is to simply use other existing lubricant technologies. An automatic spray system, using graphite-based lubricant has been proposed that uses a spray nozzle to apply liquid lubricant on the mold. This technology has known 20 years of research and development, but has had lots of development problems, such as human injuries: an operator's overalls became ignited because they had become saturated in lubricant from overspray (Bedford, 1993, Ref. 7). Renite and Graphoidal Development are two companies manufacturing this type of systems in USA.

Other related spray techniques have also been proposed. An intermediate technique between manual swabbing and automatic spraying consists in the use of a portable spray system run by an operator. It is less dangerous than manual swabbing for the operator can be away from the mold. Instead of spraying the lubricant onto the mold, it is sprayed onto the glass gob. This lubricant may have been electrostatically charged by passage between electrodes.

Carbon black technologies relying on the combination of pilot flame and C₂H₂ injection result in a high temperature and high momentum gas stream that impinges the article being coated. In addition, because of the surrounding air entrainment control of the carbon morphology deposited on the surface, it is difficult to control. Early studies conducted by Air Liquide on the morphology of the carbon coating deposited in molds, using RAMAN analysis, showed that inter-particle growth was influenced by the amount of O₂ present. The level of inter-particle growth affects the structural integrity of the deposit under mechanical shear stress as experienced in the glass mold process.

In addition, the resulting intense jet impinges on the substrate and can result in damage. For example, in recent studies carbon black was tested on coated glass surfaces to increase production by reducing the heat treatment time of the glass. In this case, the carbon black coating was used as a black body medium to improve the heat transfer characteristics of the glass.

Subsequent to the heat treatment step the carbon black coating must be removed through a washing step. Test results showed that a residue of the carbon black remained on the glass surface that was too high for practical industrialization. However, carbon deposited “cold”, i.e., no flame, showed significant reduction in residue suggesting that the interaction between the temperature and momentum of the flame with direct impingement on the coated glass surface has an affect.

Thus, there is a need in the industry to identify a method directed to overcoming, or at least reducing, the effects of one or more of the problems set forth above.

### SUMMARY

This invention relates to a method and an apparatus for producing carbon black. More particularly, the present invention relates to a method and an apparatus for the flameless production and deposition of carbon black.

As a first aspect of the present invention, a method of producing carbon black is provided. The method of producing carbon black of the present invention includes providing a reaction device. This reaction device includes a gas mixture inlet, an energy source, a reaction chamber and a reactant exit. A gas mixture is directed through the gas mixture inlet, and into the reaction chamber. As it passes the energy source, this energy source is energized, and highly-carbon-laden reactant is formed. This highly-carbon-laden reactant, which is a good source of carbon black, is then directed through the reactant exit.

As a second aspect of the present invention, a flameless method of producing carbon black is provided. The method of producing carbon black of the present invention includes providing a reaction device. This reaction device includes a gas mixture inlet, an energy source, a reaction chamber and a reactant exit. A gas mixture is directed through the gas mixture inlet, and into the reaction chamber. As it passes the energy source, this energy source is energized, and highly-carbon-laden reactant is formed. This energizing of the energy source is done entirely in the absence of any flame. This highly-carbon-laden reactant, which is a good source of carbon black, is then directed through the reactant exit

As a third aspect of the present invention, a pulsed method of producing carbon black is provided. The method of producing carbon black of the present invention includes providing a reaction device. This reaction device includes a gas mixture inlet, an inert gas inlet, an energy source, a reaction chamber and a reactant exit. A gas mixture is directed through the gas mixture inlet, and into the reaction chamber. As it passes the energy source, this energy source is energized, and highly-carbon-laden reactant is formed. A pulse of inert gas is then directed through the inert gas inlet and into the reaction chamber, wherein it forces the highly-carbon-laden reactant, which is a good source of carbon black, through the reactant exit.

As a forth aspect of the present invention, a method of producing carbon black is provided. The method of producing carbon black of the present invention includes providing a reaction device. This reaction device includes a gas mixture inlet, an energy source, a reaction chamber and a reactant exit. The reactant exit has a flow control device incorporated into it. First, this flow control device is closed. Then a gas mixture is directed through the gas mixture inlet, and into the reaction chamber. As it passes the energy source, this energy source is energized, and highly-carbon-laden reactant is formed. Then the flow control device is opened, and this highly-carbon-laden reactant, which is a good source of carbon black, is then directed through the reactant exit.

As a fifth aspect of the present invention, a pulsed method of producing carbon black is provided. The method of producing carbon black of the present invention includes providing a reaction device. This reaction device includes a gas mixture inlet, an inert gas inlet, an energy source, a reaction chamber and a reactant exit. The reactant exit has a flow control device incorporated into it. First, this flow control device is closed. Then a gas mixture is directed through the gas mixture inlet, and into the reaction chamber. As it passes the energy source, this energy source is energized, and highly-carbon-laden reactant is formed. Then the flow control device is opened, and then a pulse of inert gas is then directed through the inert gas inlet and into the reaction chamber, wherein it forces the highly-carbon-laden reactant, which is a good source of carbon black, through the reactant exit.

As a sixth aspect of the present invention, a method for continuously producing carbon black is provided. The method of producing carbon black of the present invention includes providing a reaction zone. This reaction zone includes an inlet zone, an energy source, a reaction zone and an exit zone. A stratified gas mixture is directed through the inlet zone, and into the reaction zone. This stratified gas mixture has an outer annular region of inert gas what surrounds an inner region of reacting gas mixture. As it passes through the energy zone, this energy source is energized, and stratified outlet gas is formed. This stratified outlet gas has an outer annular region of inert gas that surrounds an inner region of highly-carbon-laden reactant. This stratified outlet gas is then directed through the reactant exit.

As a seventh aspect of the present invention, an apparatus for producing carbon black is provided. The carbon black producing apparatus includes a gas mixture inlet, an energy source, a reaction chamber and a reactant exit. The energy source is either a laser, an electric arc, or both.

As an eigth aspect of the present invention, an apparatus for producing carbon black is provided. The carbon black producing apparatus includes a gas mixture inlet, an energy source, a reaction chamber, a reactant exit, and a cooling means. The energy source is either a laser, an electric, arc or both. The cooling means is a cooling fluid flowing through internal passages located within the walls of the reaction device. This cooling fluid can be acetylene, an oxidant, a mixture of acetylene, and an oxidant, an inert gas, air, or water.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a schematic of one prior art approach for removing wax from a gas stream;

FIG. 2 is a schematic of another prior art approach for removing VOC from a gas stream;

FIG. 3 is a schematic of a separation method and apparatus in accordance with one illustrative embodiment of the present invention; and

FIG. 4 is a schematic of a separation method and apparatus in accordance with one illustrative embodiment of the present invention.

### DESCRIPTION OF PREFERRED EMBODIMENTS

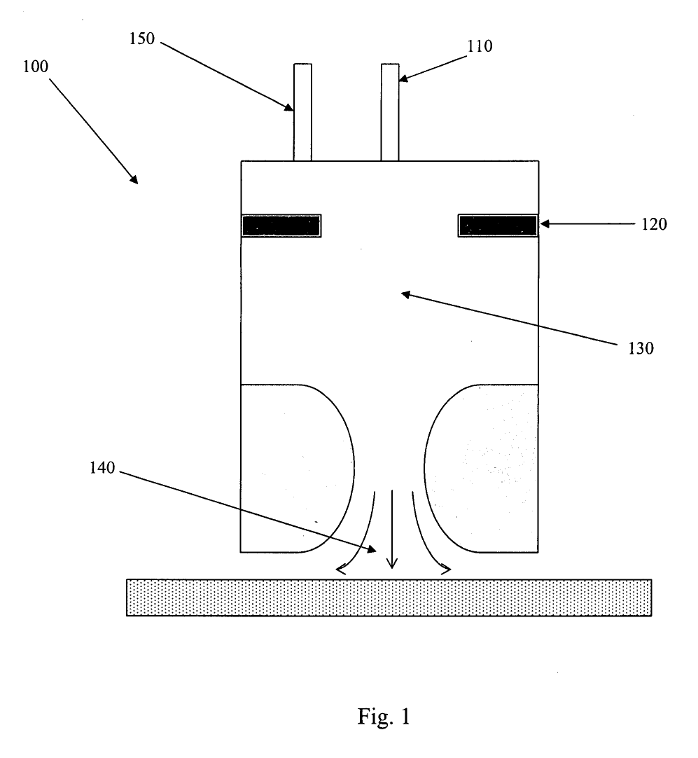

FIG. 1 depicts an illustrative embodiment of a reaction device 100 for producing carbon black according to the present invention. The reaction device 100 includes a gas mixture inlet 110, an energy source 120, a reaction chamber 130 and a reactant exit 140. A gas mixture is directed to and through gas mixture inlet 110, which is in fluid communication with reaction chamber 130. The gas mixture will flow past energy source 120. Energy source 120 is then energized, thereby producing a highly-carbon-laden reactant. This highly-carbon-laden reactant is then directed through reactant exit 140.

The gas mixture may be any gas mixture known to one skilled in the art that is capable of producing carbon black when partially burned. These gas mixtures may consist of aromatic hydrocarbon such as benzene, toluene, xylene, naphthalene, anthrathene. The gas mixtures may consist of coal type liquid fuel such as creosote oil, naphthalene oil, carbonic acid oil. The gas mixture may consist of petroleum type oil such as ethylene heavy end oil, FCC oil, etc. The gas mixture may consist of acetylene type hydrocarbons. The gas mixture may consist of ethylene type hydrocarbon, such as ethylene, propylene, aliphatic hydrocarbon such as pentane, hexane, etc. The gas mixture may consist of acetylene, or a mixture of acetylene and an oxidant.

The energy source 120 may be any such source of energy known to one skilled in the art, that is capable of introducing sufficiently controllable energy to thermally decompose, detonate, or combust incompletely the above gas mixtures in order to produce carbon black. The energy source 120 may be a laser, an electric arc, or a combination thereof. Energy source 120 may not be a flame. There may not be a continuous, stable flame, nor an intermittent flame. There may not be a pilot flame.

As used herein, the term carbon black is defined as an industrially manufactured colloidal carbon material in the form of spheres, with a fused aggregate size typically below 1000 nm.

The above described method may be used to direct this highly-carbon-laden reactant to some down stream process or surface. This downstream process, or surface, may be the internal wall of a blank glass making mold.

The above-described method may further include a cooling means. This cooling means may be any such means known to one skilled in the art that is capable of directing heat away from the reaction chamber. This cooling means may be a series of internal passages that are located in within the walls of the reaction device 100. This cooling means may use any heat transfer means or medium that is known to one skilled in the art. This cooling means may use acetylene, an oxidant, a mixture of acetylene and an oxidant, an inert gas, air or water as the heat transfer medium.

The reaction device 100 may include an inert gas inlet 250. Once the gas mixture has flowed past the energy source 120 and a highly-carbon laden reactant has been formed, a pulse of inert gas may be introduced through the inert gas inlet 250. This pulse of inert gas would thereby force the highly-carbon laden reactant through the reactant exit 140. The pulses of inert gas may be coordinated with the cyclic or intermittent down stream process, surface, or placement of the internal wall of a blank glass making mold.

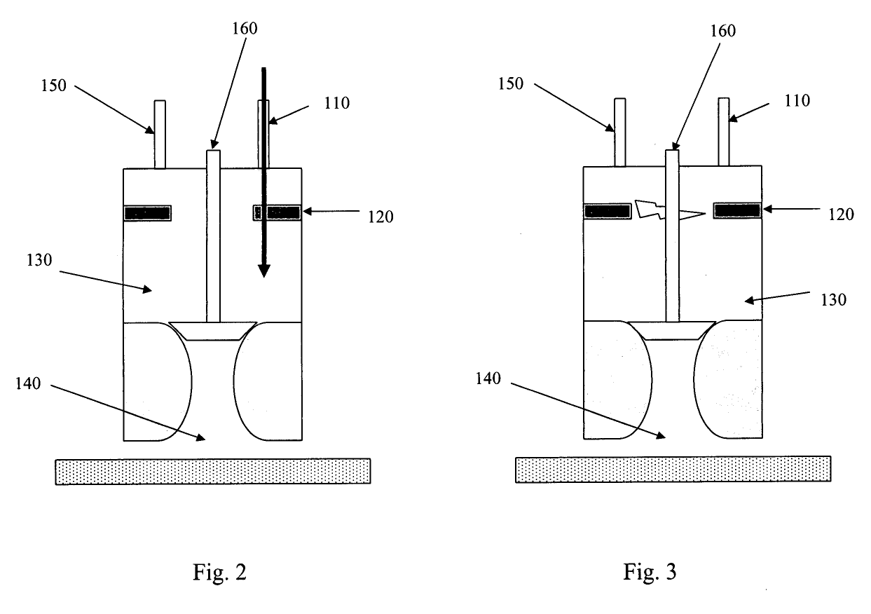

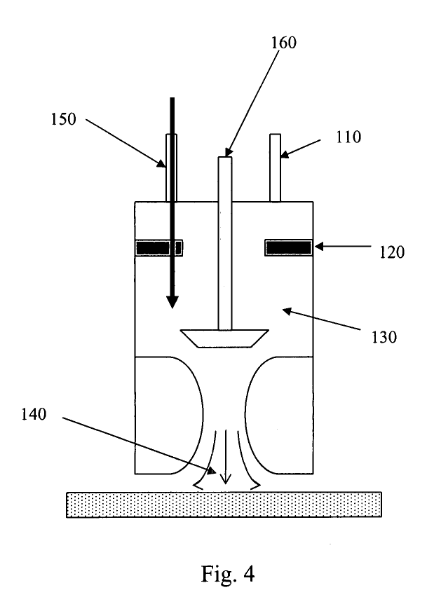

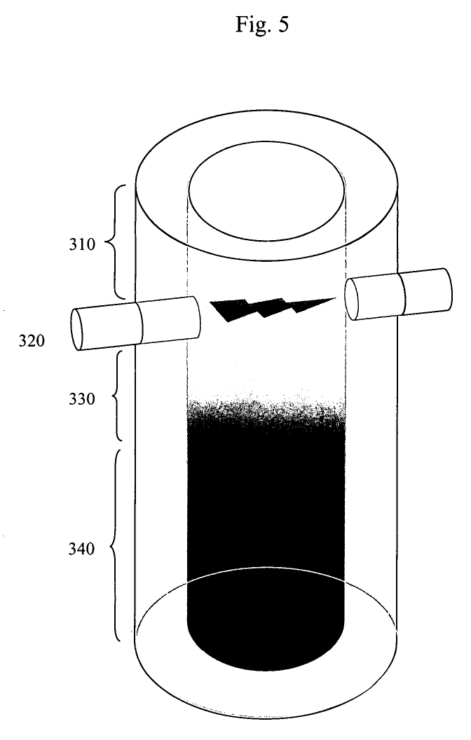

FIGS. 2 through 4 depict illustrative embodiments of a reaction device 200 for producing carbon black according to the present invention. The reaction device 200 includes a gas mixture inlet 210, an inert gas inlet 250, an energy source 220, a reaction chamber 230 and a reactant exit 240. The reactant exit 240 includes a flow control device 260. As indicated in FIG. 2, the flow control device 260 is placed in the closed position. In this position, the contents of the reaction chamber 230 are not permitted to depart through reactant exit 240. As indicated in FIG. 3, a gas mixture is then directed to and through gas mixture inlet 210, which is in fluid communication with reaction chamber 230. The gas mixture will flow past energy source 220. Energy source 220 is then energized, thereby producing a highly-carbon-laden reactant. As indicated in FIG. 4, the flow control device 260 is then placed in the open position. A pulse of inert gas may be introduced through the inert gas inlet 250. The highly-carbon-laden reactant is thereby departs through reactant exit 240.

FIG. 5 depicts an illustrative embodiment of a reaction device 300 for producing carbon black according to the present invention. The reaction device 300 includes an inlet zone 310, an energy source 320, a reaction zone 330 and an exit zone 340. A stratified gas mixture is directed to and through inlet zone 310, which is in fluid communication with reaction zone 330. The stratified gas mixture is comprised of an outer annular region of inert gas, and an inner region comprising a reacting gas mixture. The stratified gas mixture will flow past energy source 320. Energy source 320 is then energized, thereby, producing a stratified outlet gas. This stratified outlet gas is comprised of an outer annular region of inert gas, and an inner region comprising a highly-carbon-laden reactant mixture. This stratified outlet gas is then directed through exit zone 340.

Illustrative embodiments of the invention are described above. While the invention is susceptible to various modifications, and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

What is claimed is:

1. A method for producing carbon black, comprising the steps of:
a) providing a reaction device, said reaction device comprising:
i) a gas mixture inlet;
ii) an energy source;
iii) a reaction chamber;
iv) a reactant exit; and
b) directing a gas mixture to and through said gas mixture inlet, into said reaction chamber, and past said energy source;
c) energizing said energy source, thereby producing a highly-carbon-laden reactant; and
d) directing said highly-carbon-laden reactant through said reactant exit.

2. The method of claim 1, wherein said gas mixture is selected from the group consisting of acetylene and a mixture of acetylene and an oxidant.

3. The method of claim 1, wherein said energy source is selected from the group consisting of a laser and an electric arc.

4. The method of claim 1, further comprising the step of directing said highly-carbon-laden reactant to a downstream process.

5. The method of claim 4, wherein said downstream process comprises directing said highly-carbon-laden reactant to the internal wall of a blank glass making mold.

6. The method of claim 1, wherein said reaction device of step (a) further comprises:
v) a cooling means.

7. The method of claim 6, wherein said cooling means comprises a cooling fluid flowing through internal passages located within the walls of said reaction device.

8. The method of claim 7, wherein said cooling fluid is selected from the group consisting of:
a) acetylene;
b) an oxidant;
c) a mixture of acetylene and an oxidant;
d) an inert gas;
e) air; and
f) water.

9. A method for producing carbon black, comprising the steps of:
a) providing a reaction device, said reaction device comprising:
i) a gas mixture inlet;
ii) an energy source;
iii) a reaction chamber;
iv) a reactant exit; and
b) directing a gas mixture to and through said gas mixture inlet, into said reaction chamber, and past said energy source;
c) energizing said energy source, thereby producing a highly-carbon-laden reactant in the absence of a flame; and
d) directing said highly-carbon-laden reactant through said reactant exit.

10. The method of claim 9, wherein said gas mixture is selected from the group consisting of acetylene and a mixture of acetylene and an oxidant.

11. The method of claim 9, wherein said energy source is selected from the group consisting of a laser and an electric arc.

12. The method of claim 9, further comprising the step of:
(e) directing said highly-carbon-laden reactant to a downstream process.

13. The method of claim 12, wherein said downstream process comprises directing said highly-carbon-laden reactant to the internal wall of a blank glass making mold.

14. The method of claim 9, wherein said reaction device of step (a) further comprises:
v) a cooling means.

15. The method of claim 14, wherein said cooling means comprises a cooling fluid flowing through internal passages located within the walls of said reaction device.

16. The method of claim 15, wherein said cooling fluid is selected from the group consisting of:
a) acetylene;
b) an oxidant;
c) a mixture of acetylene and an oxidant;
d) an inert gas;
e) air; and
f) water.

17. A method for producing carbon black, comprising the steps of:
a) providing a reaction device, said reaction device comprising:
i) a gas mixture inlet;
ii) an inert gas inlet;
iii) an energy source;
iv) a reaction chamber;
v) a reactant exit; and
b) directing a gas mixture to and through said gas mixture inlet, into said reaction chamber, and past said energy source;
c) energizing said energy source, thereby producing a highly-carbon-laden reactant; and
d) introducing a pulse of inert gas through said inert gas inlet and into said reaction chamber, thereby forcing said highly-carbon-laden reactant through said reactant exit.

18. The method of claim 17, wherein said gas mixture is selected from the group consisting of acetylene and a mixture of acetylene and an oxidant.

19. The method of claim 17, wherein said energy source is selected from the group consisting of a laser and an electric arc.

20. The method of claim 17, further comprising the step of:
(e) directing said highly-carbon-laden reactant to a downstream process.

21. The method of claim 20, wherein said downstream process comprises directing said highly-carbon-laden reactant to the internal wall of a blank glass making mold.

22. The method of claim 17, wherein said reaction device of step (a) further comprises:
vi) a cooling means.

23. The method of claim 22, wherein said cooling means comprises a cooling fluid flowing through internal passages located within the walls of said reaction device.

24. The method of claim 23, wherein said cooling fluid is selected from the group consisting of:
a) acetylene;
b) an oxidant;
c) a mixture of acetylene and an oxidant;
d) an inert gas;
e) air; and
f) water.

25. A method for producing carbon black, comprising the steps of:
a) providing a reaction device, said reaction device comprising:
i) a gas mixture inlet;
ii) an energy source;
iii) a reaction chamber; and
iv) a reactant exit, wherein said reactant exit further comprises a flow control device; and
b) closing said flow control device;
c) directing a gas mixture to and through said gas mixture inlet, into said reaction chamber, and past said energy source;
d) energizing said energy source, thereby producing a highly-carbon-laden reactant;
e) opening said flow control device; and
f) directing said highly-carbon-laden reactant through said reactant exit.

26. The method of claim 25, wherein said gas mixture is selected from the group consisting of acetylene and a mixture of acetylene and an oxidant.

27. The method of claim 25, wherein said energy source is selected from the group consisting of a laser and an electric arc.

28. The method of claim 25, further comprising the step of:
g) directing said highly-carbon-laden reactant to a downstream process.

29. The method of claim 28, wherein said downstream process comprises directing said highly-carbon-laden reactant to the internal wall of a blank glass making mold.

30. The method of claim 25, wherein said reaction device of step (a) further comprises:
v) a cooling means.

31. The method of claim 30, wherein said cooling means comprises a cooling fluid flowing through internal passages located within the walls of said reaction device.

32. The method of claim 31, wherein said cooling fluid is selected from the group consisting of:
a) acetylene;
b) an oxidant;
c) a mixture of acetylene and an oxidant;
d) an inert gas;
e) air; and
f) water.

33. A method for producing carbon black, comprising the steps of:
a) providing a reaction device, said reaction device comprising:
i) a gas mixture inlet;
ii) an inert gas inlet;
iii) an energy source;
iv) a reaction chamber; and
v) a reactant exit, wherein said reactant exit further comprises a flow control device; and
b) closing said flow control device;
c) directing a gas mixture to and through said gas mixture inlet, into said reaction chamber, and past said energy source;
d) energizing said energy source, thereby producing a highly-carbon-laden reactant;
e) opening said flow control device; and
f) introducing a pulse of inert gas through said inert gas inlet and into said reaction chamber, thereby forcing said highly-carbon-laden reactant through said reactant exit.

34. The method of claim 33, wherein said gas mixture is selected from the group consisting of acetylene and a mixture of acetylene and an oxidant.

35. The method of claim 33, wherein said energy source is selected from the group consisting of a laser and an electric arc.

36. The method of claim 33, further comprising the step of:
g) directing said highly-carbon-laden reactant to a downstream process.

37. The method of claim 36, wherein said downstream process comprises directing said highly-carbon-laden reactant to the internal wall of a blank glass making mold.

38. The method of claim 33, wherein said reaction device of step (a) further comprises:
vi) a cooling means.

39. The method of claim 38, wherein said cooling means comprises a cooling fluid flowing through internal passages located within the walls of said reaction device.

40. The method of claim 39, wherein said cooling fluid is selected from the group consisting of:
a) acetylene;
b) an oxidant;
c) a mixture of acetylene and an oxidant;
d) an inert gas;
e) air; and
f) water.

41. A method for continuously producing carbon black, comprising the steps of:
a) providing a reaction region, said reaction region comprising:
i) an inlet zone;
ii) an energy source;
iii) a reaction zone;
iv) an exit zone; and
b) introducing a stratified inlet gas comprising an outer annular region of inert gas surrounding an inner region of reacting gas mixture;
c) directing said stratified gas through said inlet zone, into said reaction zone and past said energy source;
d) energizing said energy source, thereby producing a stratified outlet gas, said stratified outlet gas comprising an outer annular region of inert gas surrounding an inner region of highly-carbon-laden reactant; and
e) directing said stratified outlet gas through said exit zone.

42. The method of claim 41, wherein said gas mixture is selected from the group consisting of acetylene and a mixture of acetylene and an oxidant.

43. The method of claim 41, wherein said energy source is selected from the group consisting of a laser and an electric arc.

44. The method of claim 41, further comprising the step of:
f) directing said highly-carbon-laden reactant to a downstream process.

45. The method of claim 44, wherein said downstream process comprises directing said highly-carbon-laden reactant to the internal wall of a blank glass making mold.

46. The method of claim 41, wherein said reaction device of step (a) further comprises:
v) a cooling means.

47. The method of claim 46, wherein said cooling means comprises a cooling fluid flowing through internal passages located within the walls of said reaction device.

48. The method of claim 47, wherein said cooling fluid is selected from the group consisting of:
a) acetylene;
b) an oxidant;
c) a mixture of acetylene and an oxidant;
d) an inert gas;
e) air; and
f) water.

49. An apparatus for producing carbon black, comprising:
a) a gas mixture inlet;
b) an energy source, wherein said energy source is selected from the group consisting of a laser and an electric arc;
c) a reaction chamber; and
d) a reactant exit.

50. An apparatus for producing carbon black, comprising:
a) a gas mixture inlet;
b) an energy source, wherein said energy source is selected from the group consisting of a laser and an electric arc;
c) a reaction chamber;
d) a reactant exit; and
e) a cooling means, wherein said cooling means comprises a cooling fluid flowing through internal passages located within the walls of said reaction device, and wherein said cooling fluid is selected from the group consisting of:
i) acetylene;
ii) an oxidant;
iii) a mixture of acetylene and an oxidant;
iv) an inert gas;
v) air; and
vi) water.
